(19) United States
(12) Patent Application Publication
(10) Pub. No.: US 2006/0277894 A1
(43) Pub. Date: Dec. 14, 2006

(54) Chain

(76) Inventor: Pei Chuan Lin, Taichung City (TW)

Correspondence Address: PRO-TECHTOR INTERNATIONAL SERVICES, 20775 NORADA CT., SARATOGA, CA, 95070, US

(21) Appl. No.: 11/148,629

(22) Filed: Jun. 8, 2005

(51) Int. Cl. F16G 13/00

(52) U.S. Cl. 59/80

(57) ABSTRACT

A chain is disclosed to include a plurality of chain elements each having two pivot holes at the two distal ends, a plurality of U-shaped links respectively inserted into the pivot holes to connect the chain elements in series, a plurality of acorn nuts respectively threaded onto the threaded ends of each of the U-shaped links to secure the U-shaped links to the chain elements, and a buckle formed of a female buckle member and a male buckle member for joining the ends of the chain.

### BACKGROUND OF THE INVENTION

1. Field of the Invention

The invention relates to a chain and more particularly, to such a chain that can conveniently be assembled subject to the desired length and mounted with a buckle to form a pet collar.

2. Description of the Related Art

A regular chain is series of connected rings or links. Different designs of rings or links may be connected to form different chains for different purposes. A chain of oval rings formed of metal wire rods can be used as a collar for pet. When using a chain of this design for pet collar, the two ends of the chain must be welded together or fastened together with fastening means. When a chain type pet collar is made, its length is not adjustable.

Further, it is difficult to show a design on the surface of a pet collar that is made of a chain, leather, or fabric material.

### SUMMARY OF THE INVENTION

The present invention has been accomplished under the circumstances in view.

It is therefore the main object of the present invention to provide a chain that can conveniently be assembled or adjusted subject to the desired length.

It is another object of the present invention to provide a chain that carries a design on the surface to give a message.

It is still another object of the present invention to provide a chain that can be used with a buckle to form a pet collar that can conveniently adjusted to fit the size of the pet's neck.

According to one aspect of the present invention, the chain comprises a plurality of chain elements each having two pivot holes at the two distal ends, a plurality of U-shaped links respectively inserted into the pivot holes to connect the chain elements in series, and a plurality of acorn nuts respectively threaded onto the threaded ends of each of the U-shaped links to secure the U-shaped links to the chain elements.

According to another aspect of the present invention, a buckle is used with the chain for joining the ends of the chain to secure the chain to the neck of a pet.

According to still another aspect of the present invention, each chain element carries a respective design that can be a letter or pattern.

### BRIEF DESCRIPTION OF THE DRAWING

FIG. 1 is an elevational view of a chain according to the present invention.

FIG. 2 is an exploded view in an enlarged scale of a part of the chain shown in FIG. 1.

FIG. 3 is a sectional view in an enlarged scale of a part of the chain shown in FIG. 1.

FIG. 4 is a plain view of a pet collar constructed according to the present invention.

FIG. 5 is an elevational view of the pet collar constructed according to the present invention.

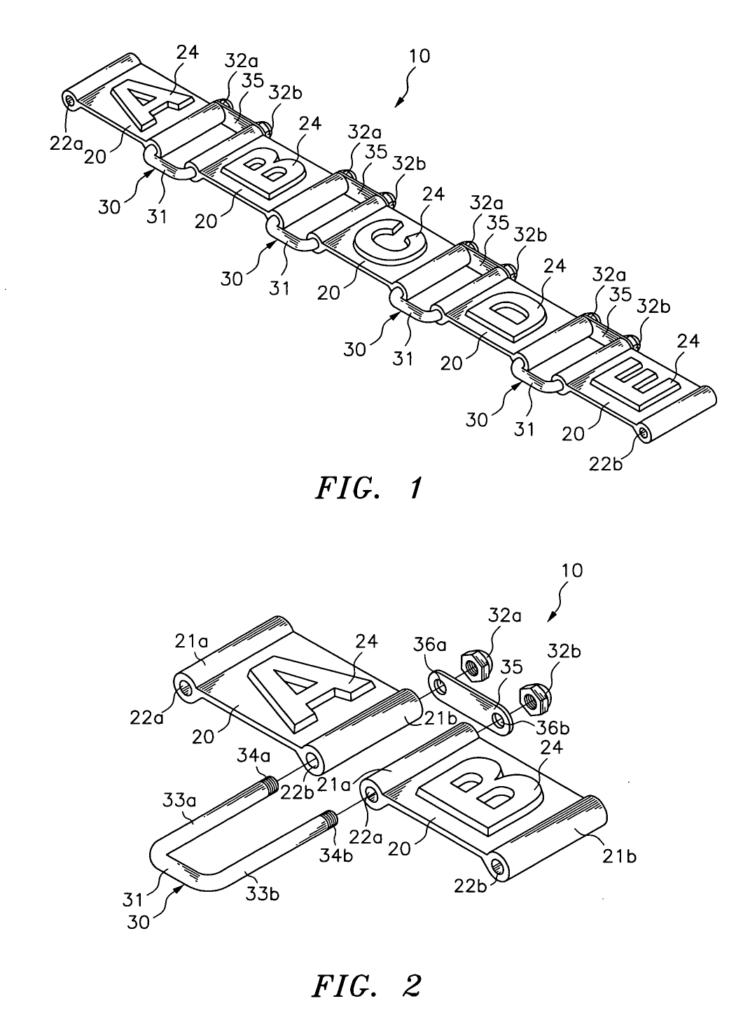

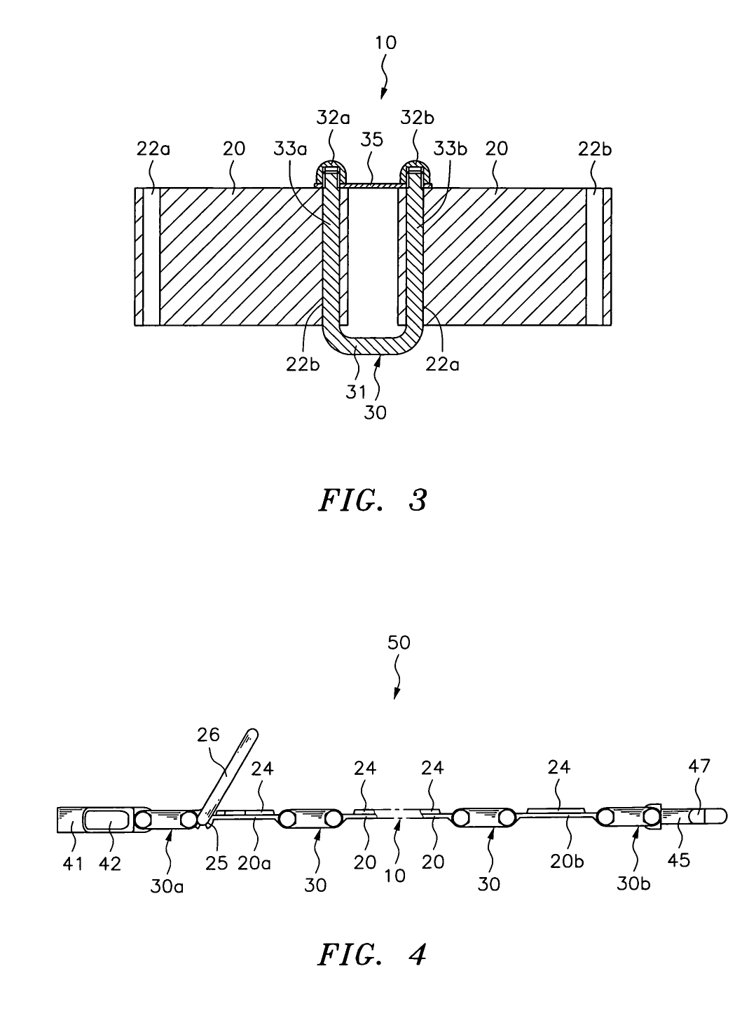

### DETAILED DESCRIPTION OF THE PREFERRED EMBODIMENT

Referring to FIGS. 1˜3, a chain 10 in accordance with the present invention is shown comprised of a plurality of chain elements 20, and a plurality of fasteners 30 that connect the chain elements 20 in series. The chain elements 20 are rectangular plate members each having a thickened first end portion 21a transversely disposed at one end, a thickened second end portion 21b transversely disposed at the other end, a first transverse pivot hole 22a extending through the two ends of the transversely disposed first end portion 21a, and a second transverse pivot hole 22b extending through the two ends of the transversely disposed second end portion 21b.

Each fastener 30 comprises a link 31, a constraint plate 35, and two acorn nut 32a and 32b. The link 31 is shaped like a U-bar, having two parallel rod-like arms 33a and 33b. The arms 33a and 33b each have one end joined to each other and the other end respectively terminating in a threaded tip 34a or 34b. The diameter of the arms 33a and 33b is smaller than the diameter of the first transverse pivot hole 22a and the diameter of the second transverse pivot hole 22b. The constraint plate 35 is an oblong plate having two through holes 36a and 36b near the two distal ends. By means of inserting the two arms 33a and 33b of the link 31 through the first transverse pivot hole 22a of one chain element 20 and the second transverse pivot hole 22b of another chain element 20 and the two through holes 36a and 36b of the constraint plate 35 and then threading the two acorn nuts 32a and 32b onto the threaded tips 34a and 34b of the link 31, two chain elements 20 are pivotally connected together. The constraint plate 35 is a tough plate coupled to the two parallel rod-like arms 33a and 33b of the link 31 and stopped between the acorn nuts 32a and 32b and the corresponding two chain elements 20 to constrain the two arms 33a and 33b of the link 31, preventing curving of the arms 33a and 33b of the link 31 by an external force accidentally.

As indicated above, the chain 10 is comprised of a plurality of chain elements 20 that are connected in series by U-shaped links 31 and constraint plates 35 and acorn nuts 32a and 32b, the length of the chain 10 can conveniently adjusted by means of adding or reducing the number of the chain elements 20 and the fasteners 30. Therefore, if the length of the chain 10 does not meet the demand after a long use, the user can conveniently change the length of the chain 10 and needs not to buy a new chain.

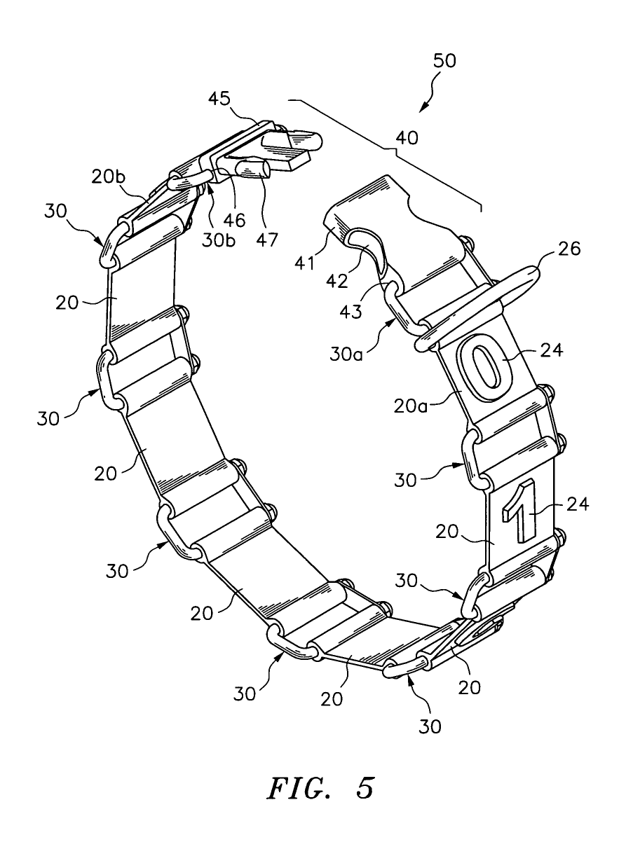

According to the chain 10 shown in FIG. 1, the number of the chain elements 20 is one more than the number of the fasteners 30. Two additional fasteners 30a and 30b may be fastened to the first transverse pivot hole 22a of the first chain element 20a of the chain 10 and the second transverse pivot hole 22b of the last chain element 20b of the chain 10 to secure the female buckle member 41 and male buckle member 45 of a buckle 40 to the chain 10 for joining the ends of the chain 10 to form a pet collar 50 (see FIGS. 4 and 5). The female buckle member 41 has two retaining holes 42 respectively formed in the left and right sidewalls, and a coupling hole 43 transversely extending through the left and right sidewalls near the rear side for receiving one arm 33a of the link 31 of the fastener 30a. The other arm 33b of the link 31 of the fastener 30a is inserted through the first transverse pivot hole 22a of the first chain element 20a of the chain 10. The male buckle member 45 has two springy hooks 47 that can be inserted into the female buckle member 41 and forced into engagement with the retaining holes 42, and a coupling hole 46 transversely extending through the left and right sidewalls near the rear side for receiving one arm 33b of the link 31 of the fastener 30b. The other arm 33a of the link 31 of the fastener 30b is inserted through the second transverse pivot hole 22b of the last chain element 20b of the chain 10. After fastening of the respective acorn nuts 32a and 32b and constraint plates 35 to the respective links 31 of the respective fasteners 30a and 30b, the chain 10 and the buckle 40 are fastened together.

Referring to FIGS. 4 and 5 again, the first chain element 20a has a coupling groove 25 of substantially C-shaped cross section formed in the bottom side of the first chain element 20a of the chain 10 of the pet collar 50, and a D-shaped hanger 26 is pivotally coupled to the coupling groove 25 of the first chain element 20a for the mounting of a drag rope or a swinging hook at one end of a drag rope (not shown).

The chain elements 20a and 20b and fasteners 30a and 30b shown in FIGS. 4 and 5 are same as respective chain elements 20 and respective fasteners 30 shown in FIG. 1.

Referring to FIGS. 1 and 5 again, because the chain elements 20, 20a and 20b are rectangular plate members, they have a broad surface area for showing a design. For example, the surface of each of the chain elements 20, 20a and 20b has a respective design 24 that can be an English letter, numeral, pattern and/or the like. For example, the designs 24 of the chain elements 20, 20a and 20b of the pet collar 50 can be so arranged to show a telephone number or the pet's name.

Further, the chain elements 20, 20a and 20b can be cast from a non-ferro alloy, such as zinc alloy, aluminum alloy, magnesium alloy, copper alloy, lead alloy, and tin alloy. However, zinc alloy is the best choice for the advantage of low melting point, ease of casting, high strength, smooth surface, and cheap cost. Alternatively, the chain elements 20, 20a and 20b can be molded from plastics. The design 24 can be directly formed in the chain elements 20, 20a and 20b. Alternatively, the design 24 can be made in the form of a sticker and then adhered to the chain elements 20, 20a and 20b.

A prototype of chain has been constructed with the features of FIGS. 1˜5. The chain functions smoothly to provide all of the features discussed earlier.

Although particular embodiments of the present invention have been described in detail for purposes of illustration, various modifications and enhancements may be made without departing from the spirit and scope of the invention. Accordingly, the invention is not to be limited except as by the appended claims.

What the invention claimed is:

1. A chain comprising:
a plurality of chain elements, said chain elements each having a first end, a second end, a first pivot hole at said first end, and a second pivot hole at said second end; and
a plurality of fasteners for connecting said chain elements in series, said fasteners each comprising a link, said link having a first arm inserted through the first pivot hole of one of said chain elements and a second arm inserted through the second pivot hole of another one of said chain elements, said first arm and said second arm each having a threaded tip, and two nuts for threading onto the threaded tips of the arms of the respective fastener to secure the respective fastener to the two chain elements through which the respective fastener is inserted.

2. The chain as claimed in claim 1, wherein said chain elements each have a letter formed thereon.

3. The chain as claimed in claim 1, wherein said chain elements each have a pattern formed thereon.

4. The chain as claimed in claim 1, wherein said fasteners each further comprise a constraint plate respectively mounted on the first arm and second arm of the respective fastener and stopped between two adjacent ones of said chain elements and the nuts of the respective fastener, said constraint plate having two through holes near two distal ends thereof for the passing of the first arm and second arm of the respective fastener.

5. The chain as claimed in claim 1, further comprising a buckle for joining a first chain element and a last chain element of the chain after said chain elements have been connected in series by said fasteners, said buckle comprising a female buckle member fastened to the first chain element of the chain and a male buckle member fastened to the last chain element of the chain and connectable to said female buckle member.

6. The chain as claimed in claim 5, wherein said female buckle member and said male buckle member each have a pivot hole respectively pivotally connected to the first chain element and last chain element of the chain by a respective fastener.

7. The chain as claimed in claim 5, further comprising a D-shaped hanger pivotally coupled to a coupling groove at a bottom side of the first chain element of the chain.

8. The chain as claimed in claim 6, further comprising a D-shaped hanger pivotally coupled to a coupling groove at a bottom side of the first chain element of the chain.
